(19) United States
(12) Patent Application Publication
(10) Pub. No.: US 2009/0255758 A1
(43) Pub. Date: Oct. 15, 2009

(54) Novel rear deck service ladder and handle assembly for combines

(76) Inventors: Herbert M. Farley, Elizabethtown, PA (US); Andrew V. Lauwers, Stevens, PA (US); Marion D. Mencer, III, Lancasler, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/082,932

(22) Filed: Apr. 15, 2008

(51) Int. Cl. E06C 5/00; E06C 5/04; E06C 7/04

(52) U.S. Cl. 182/88; 182/127; 16/408

(57) ABSTRACT

A novel rear deck service ladder and handle assembly for combine harvesters is disclosed having integral latching and height adjustment features.

### TECHNICAL FIELD

The present invention relates to devices and methods for accessing the engine servicing platforms of combine harvesters, and it particularly relates to latches and handle assemblies for using such ladders at the rear of a combine.

### BACKGROUND ART

A variety of different ladders are presently known to provide access between the ground and the engine service platform of a combine. Folding ladders incorporating spring biased over-centering linkages to hold the ladders in stowed or closed positions without the need of a separate latching mechanism, have been known since 1978 from U.S. Pat. No. 4,131,293 by Kindle. However, typical ladders for combines remain relatively short, on the order of three to five steps, and typically the ladders simply swing or pivot from deployed position into a position for storage. Additionally, several folding step arrangements are in the prior art. Also ladders that fold into or against a vehicle body are known, and there are known embodiments utilizing tracks to align a ladder into a storage hold.

However, there are certain recent model combines which have functional drawbacks inhibiting the deployment of ladders at the extreme rear end of the combine. Principally, among these drawbacks, is the difficulty of accommodating the discharge of straw and other M.O.G. (material other than grain) at the rear of the combine. That is, the ladder must be stored while also allowing ample room for the discharging straw and M.O.G. to flow freely, without being obstructed by the ladder. For purposes of homologation, the ladder, when deployed, must be long enough to extend beyond the discharge opening. Also, prior art ladders do not accommodate variations in vehicle height resulting from variation in the tire package. Furthermore, the ladders, when in the storage position at the rear, will accumulate straw and M.O.G. discharge, which subsequently spills onto the operator when he manually deploys the ladder into the service position. Also, the secondary mechanisms for positioning the access ladders in either the storage or working positions, such as push/pull cables or linkages would typically be inaccessible and unreliable at the rear of the combine.

An adjustable handle and latching mechanism, for positively positioning rear ladders, that would be reliable and accessible, would provide an unexpected advancement in combine harvester design, while satisfying a longfelt need for rearwardly accessing combine harvester engine service platforms, when there is a discharge port located at the rear of the combine.

### SUMMARY OF THE INVENTION

The above-described drawbacks and others which will be apparent to those skilled in the art are overcome by a ladder assembly 40 that features a storage latch 23 whose release actuation 63 is integrated into its handle assembly 20. A handle arm 27 of handle assembly 20, attached to a rotatable bracket 21, when lifted, rotates the bracket 21, via a curved slot and stop button 53, into contacting a latch 23 having a release lever 60 biased by a tension spring 62, allowing adequate travel for a protrusion 63 on the bracket 21 to slowly actuate release, while maintaining secure feel for the operator when latching and unlatching the ladder during deployment from its storage position. Trim panels 50, on the combine, protect the handle 20 for the ladder 40 deployment from varying heights, and allow modifying an individual ladder's access or grasping point 26.

### BRIEF DESCRIPTION OF THE DRAWINGS

FIG. 1 is a left side perspective of the rear access platform and ladder assembly of a combine incorporating the present invention;

FIG. 2 is a perspective view of a “prior art” combine having its access ladder on the right-hand side of the combine;

FIG. 3 is a perspective view of a combine showing the rear access ladder of the present invention in its stored position;

FIG. 4 is a left side view of the handle assembly of the present invention in its stored position;

FIG. 5 is a left side view of the handle assembly of FIG. 4 rotated 5-15° in direction A so as to trip the release of the ladder but prior to unfolding its bottom portion;

FIG. 6 shows a left side view of the positioning of the handle assembly of the present invention as it is adjusted to the desired height;

FIG. 7 is a perspective close-up view of a latch mechanism for the present invention;

FIG. 8 shows a left side view of the combined ladder and handle assemblies of the present invention when the ladder is in the stored position;

FIG. 9 is a left side view of the combined assembly of FIG. 8 as it is initially moved toward full deployment;

FIG. 10 is a left side view of the combined assembly fully deployed but before the ladder's lower section is deployed; and

FIG. 11 is a left side perspective of the combined assembly fully deployed.

### DETAILED DESCRIPTION OF THE INVENTION

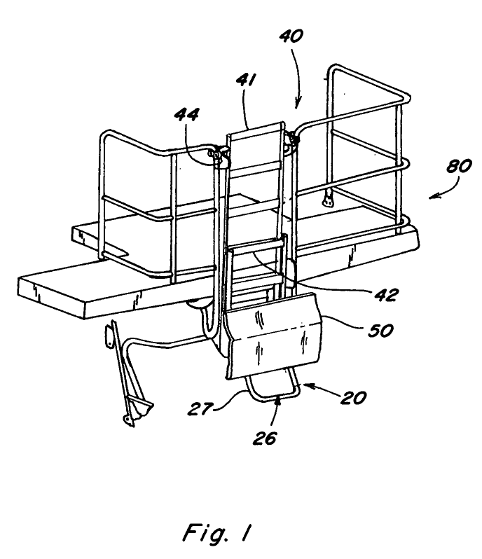

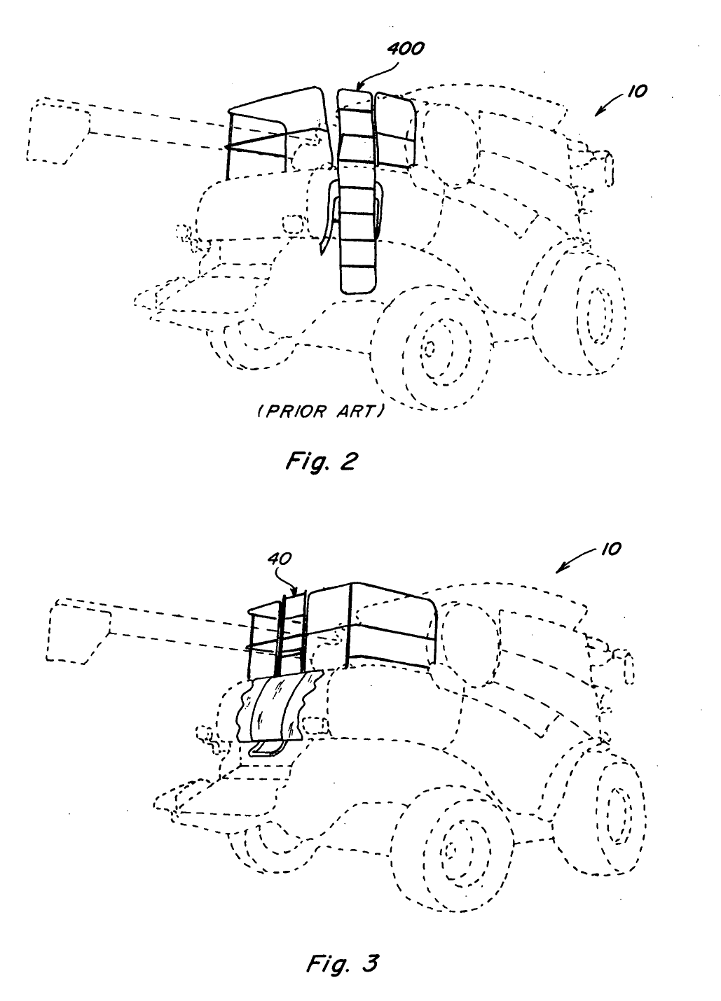

Referring generally to the accompanying drawings, the invention disclosed herein can be illustrated on an agricultural vehicle such as the combine shown generally as 10. The combine will typically include the customary chassis or body side walls, and wheels. An operator's platform 80 for an engine service and access catwalk and guardrails is provided at the rear end of the combine. Referring to FIG. 1, the rear access ladder assembly 40 of the present invention is integrally stored in upright fashion on the rear access platform 80 so as to define a movable extension of the handrails. This configuration is in contrast to the prior art access ladder 400 configuration as shown in FIG. 2 which is located on the right-hand side of the engine service platform 80.

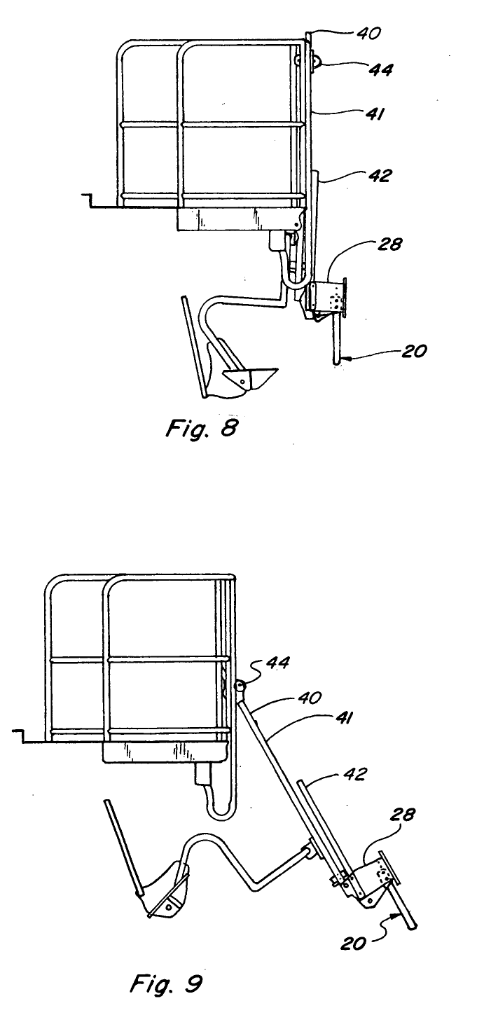

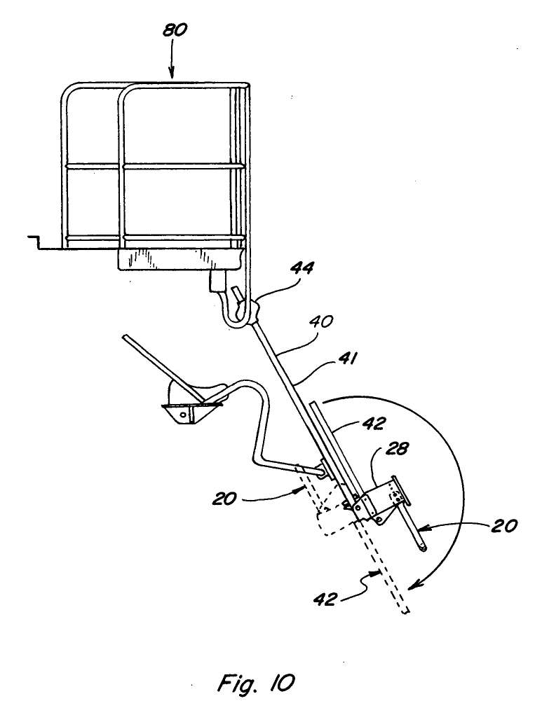

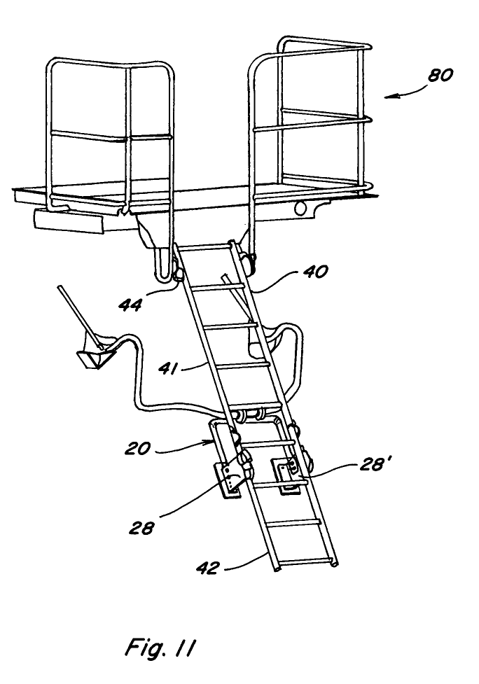

Referring to the drawings, somewhat out-of-order, FIGS. 8, 9, 10 and 11, illustrate a progression from FIG. 8, where the rear access ladder assembly 40 of the platform 80 is fully stowed away, to FIG. 9 where the ladder 40 is partially deployed into service, to FIG. 10 where the ladder assembly 40 is more advanced into service, and finally FIG. 11 where ladder assembly 40 is fully deployed and unfolded. Ladder assembly 40 comprises two hinged portions 41 and 42. Ladder portion 41 defines a longer upper portion of ladder 40, which portion 41 is slidingly engaged at its top end rollers 44 to move up and down along two handrails of ladder 40. Trim panel attachment 50 attaches to the bridge plates 28 and 28′.

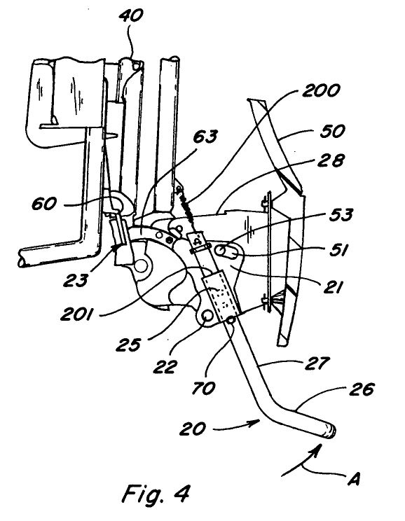

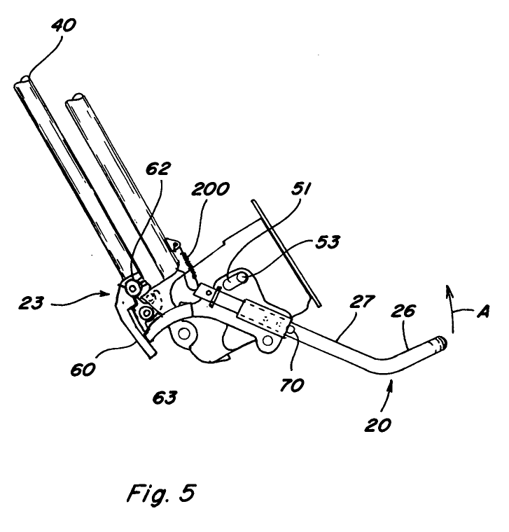

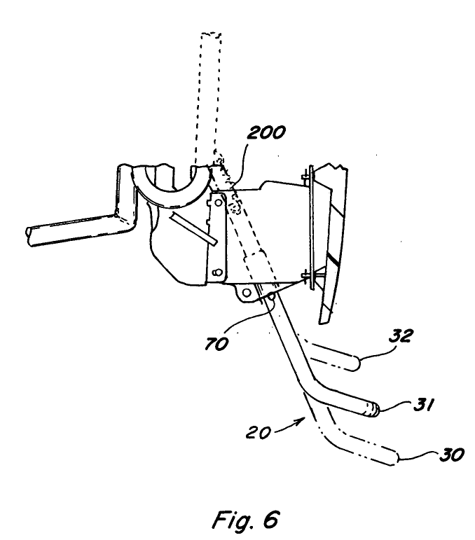

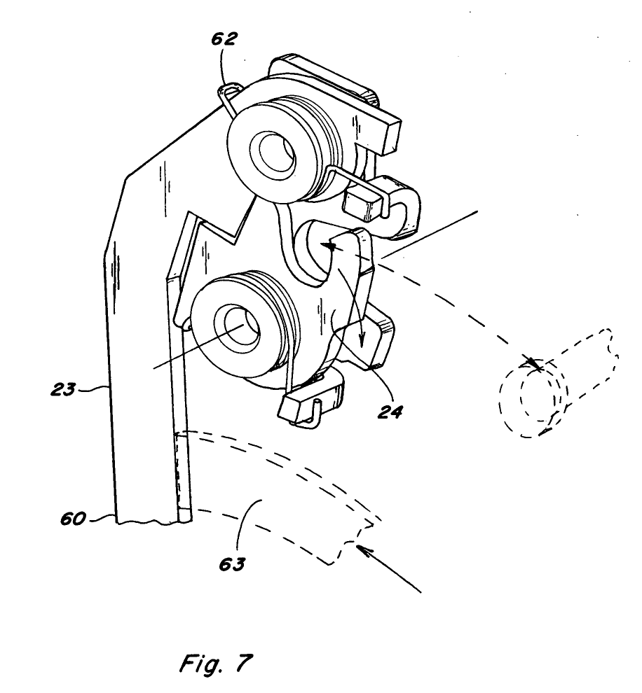

Handle assembly 20 is preferably U-shaped and is illustrated in FIGS. 4, 5, 6 and 7. Referring now to FIG. 4, a storage latch mechanism 23 cooperates with the release actuation contact 63 which is integrated into pivot bracket 21, which bracket supports handle assembly 20 that extends downward therefrom. The bracket 21 is rotatably fitted flush against bridge plate 28 and rotates about pivot point 22 via slot 51 until stop notch 53 stops said rotation. There is a similar bracket assembly 21′ rotatably fitted onto bridge plate 28′. Thus, handle 20 if rotated for about 5°-15° in accordance with directional arrow A, its protrusion 63 creates contact with latch member 23, at latch release lever 60, to release said latch 23 against the bias of tension spring 62 (see FIG. 7), and in turn to release ladder assembly 40 from its secure storage position. The rotational movement is constrained by virtue of a curved slot 51 which guides the back end of pivot bracket 21 about stop notch 53 and against a tension spring 200. This movement provides adequate travel so that the stop notch element 53 of bridge plate 28 which is stationary within the slot while also maintaining a firm, secure station for handle 20 when being gripped by the operator at grasp point 26. Handle 20 features multiple height positions 20 by virtue of spring loaded pin 70 that can be moved into either of several holes 25 in pivot bracket 21 or in a sleeve 201 attached to said bracket 21 and, said height positioning of handle 20 working against the tension of spring 200. Pivot bracket 21 rotates around its pivot point 22 by way of said pivot point 22 being a pin or the like fixed into bridge plates 28/28′ to support the handle 20 position between trim member 50 and ladder 40. Handle assembly 20 has a vertical arms 27 and 27′, which arm 27 is the portion of handle assembly 20 extending up through sleeve 201 on pivot bracket 21 on the left side of the handle 20 assembly. FIG. 7 shows jaw member 24 of latch 23 and serves as a secondary device having the primary function of positively securing and positioning ladder 40 in either the storage or working (deployed) position. A duplicate pivot plate 21′ is rotatably fixed on a bridge plate 28′ fixed opposite of bridge plate 28 connecting or bridging the ladder assembly 40 and trim 50.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A ladder assembly for rear access to a combine harvester comprising:
(a) a retractable ladder having an upper portion which slidably retracts from deployment into stowed or storage position, and folds against a smaller bottom portion; and
(b) a handle assembly, having a handle connected to the ladder between the upper and lower portion, and allowing said ladder to be manually grasped and manipulated, and pulled into deployment, said handle assembly having integrated therein a tripping element for a latching mechanism which mechanism serves to lock and unlock said ladder in and from storage, and which tripping element strikes a latch, upon rotation of the handle mechanism, and will release said ladder assembly from its storage position to enable deployment; and
(c) said handle assembly being rotatable around a horizontal pivot axis on the ladder assembly which rotation actuates release of said latching member for the retractable ladder assembly.

2. The handle assembly of claim 1 wherein the handle is spring loaded to extend vertically downward and independently of effecting the latching or release of the ladder.

3. The ladder assembly of claim 1 wherein the handle assembly is U-shaped.

4. The handle assembly of claim 1 wherein a 5-15° rotation unlatches the entire ladder assembly from its storage position.

5. The handle assembly of claim 1 wherein the handle rotates on a pivotal bracket having a protrusion, which protrusion is the tripping mechanism and strikes a release lever on a latch member which latch member is integral to the ladder.

6. The handle assembly of claim 2, wherein grasping and rotating of the handle by an operator, allows deployment from multiple heights.
